(19) United States
(12) Patent Application Publication
(10) Pub. No.: US 2006/0087385 A1
(43) Pub. Date: Apr. 27, 2006

(54) System and method for duplex operation using a hybrid element

(75) Inventors: Douglas D. Fitzpatrick, Madison, AL (US); Herbert U. Fluhler, Madison, AL (US); Dennis L. Troutman, Huntsville, AL (US); James L. Richards, Fayetteville, TN (US)

Correspondence Address: JAMES RICHARDS, 58 BONING RD, FAYETTEVILLE, TN, 37334, US

(73) Assignee: Time Domain Corporation, Huntsville, AL (US)

(21) Appl. No.: 10/971,383

(22) Filed: Oct. 22, 2004

(51) Int. Cl. H01P 5/18

(52) U.S. Cl. 333/117; 333/21 A

(57) ABSTRACT

A system for duplex transmission and reception utilizing circular polarization wherein a pair of linear polarized orthogonal antennas is coupled to a transmitter through a hybrid coupler and a receiver is coupled to the antennas via the same hybrid coupler by using the port isolated from the transmitter. The hybrid may be a quadrature hybrid coupler or may comprise a 180 degree hybrid combined with a 90 degree phase shift network. Embodiments are shown for receiving a first reflection (opposite handed sense) circular polarized wave and alternatively, for receiving a second reflection (same handed sense) (multi-path) circular polarized wave.

### FIELD OF THE INVENTION

The present invention pertains generally to the field of radio frequency transmission and reception systems, and more particularly to duplex operation of transmitters and receivers utilizing circular polarized signals.

### BACKGROUND OF THE INVENTION

Modern RF devices are following the path of computer devices by becoming smaller, lower cost and are proliferating in application, increasingly used in consumer and commercial applications. As more applications are pursued, there is pressure to lower the cost, size and complexity of the RF components to meet marketing requirements for the new devices.

Ultra Wideband radar is increasingly proposed to solve problems such as security systems, detection and measurement of objects, assessment of materials, detection of objects in the ground, and many more.

One of the problems in small ultra wideband systems is designing a low cost fast duplexer based on a Transmit/Receive (T/R) switch that allows sensing of very close radar signal returns within, for example, a few meters. Typical T/R switches present power consumption, switching control, and settling time issues which limit their switching speed to a few nanoseconds.

Ultra wideband systems may also need low cost duplexing of a common antenna between a transmitter and receiver. T/R switches can be used, but can be disadvantageous in terms of element costs and the need for specific power voltage levels; particularly when higher power RF is employed. Separate transmit and receive antennas have also been proposed, but the use of separate antennas increases the antenna footprint and can present difficult configuration issues. Band splitting diplexers can defeat the wide bandwidth of UWB and are not appropriate for systems that must use the same frequency band for both transmit and receive.

Thus, there is a need for a simple, low cost, efficient method for duplexing a transmitter and receiver, which is applicable to all RF systems including Ultra Wideband systems and in particular to Ultra Wideband radar and sensor systems. Further, there is a need for a simple low cost efficient method of duplexing an ultra wideband radar for very close range sensing applications.

### BRIEF DESCRIPTION OF THE INVENTION

Briefly, the present invention is a system for duplex transmission and reception utilizing circular polarization wherein a pair of orthogonal linear polarized antennas is coupled to a transmitter through a −3 dB 90 degree hybrid coupler and a receiver is also coupled to the pair of antennas via the isolated port of the hybrid coupler.

In one embodiment, a pair of cross polarized antennas (also called orthogonal linear polarized antennas) are coupled to a UWB transmitter and a UWB receiver by using the input and isolated ports of a hybrid. In another embodiment, the transmitter and receiver may operate in overlapping time intervals. In another embodiment duplex operation is achieved without the use of a T/R switch.

In an alternative embodiment, a transmitter and receiver are coupled to a pair of cross polarized antennas using a 180 degree hybrid and a 90 degree delay.

In an alternative embodiment, a transmitter and receiver are coupled to a pair of cross polarized antennas using a zero degree hybrid and a 90 degree delay.

In a further embodiment, phase shift or delay may be introduced to adjust the system to proper circular polarization performance by adjusting the delay in a coupling line or network or by spacing the antennas.

These and further benefits and features of the present invention are herein described in detail with reference to exemplary embodiments in accordance with the invention.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A and FIG. 1B illustrate a UWB transmitter and UWB receiver coupled to a pair of antennas in accordance with the present invention.

FIG. 2A and FIG. 2B illustrate one exemplary embodiment of the cross polarized antenna.

FIG. 3 illustrates the primary and first multipath reflection of a circular polarized signal

FIG. 4 illustrates a radar system in accordance with the present invention.

### DETAILED DESCRIPTION OF THE PREFERRED EMBODIMENTS

The present invention utilizes a hybrid coupler to couple two cross polarized antennas to a transmitter and receiver. The transmitter is coupled to the hybrid input port and the receiver is coupled to the hybrid isolated port.

Since the hybrid coupler is a low loss, passive device, it consumes no DC power and contributes very little RF loss. Further, hybrid couplers can handle very high RF power levels and may be made using low cost strip line techniques making them suitable for consumer and commercial applications.

Since the hybrid includes no switching operations, switching time and settling time considerations of a T/R switch are nonexistent, enabling very close timing of transmit and receive, even to include overlapping operation, which enables close range radar and sensing devices.

Ultra Wideband Background

The following is an overview of impulse radio as an aid in understanding the benefits of the present invention.

Ultra Wideband is an emerging RF technology with significant benefits in communications, radar, positioning and sensing applications. In 2002, the Federal Communications Commission (FCC) recognized these potential benefits to the consumer and issued the first rulemaking enabling the commercial sale and use of products based on Ultra Wideband technology in the United States of America. The FCC adopted a definition of Ultra Wideband to be a signal that occupies a fractional bandwidth of at least 0.25, or 1.5 GHz bandwidth at any center frequency. The fractional bandwidth is more precisely defined as:

$$FBW = \frac{2 ( {f}_{h} - {f}_{l} )}{{f}_{h} + {f}_{l}} ,$$

where FBW is the fractional bandwidth, fh is the upper band edge and fl is the lower band edge, the band edges being defined as the 10 dB down point in spectral density.

There are many approaches to UWB including impulse radio, direct sequence CDMA, ultra wideband noise radio, direct modulation of ultra high-speed data, and other methods. The present invention has its origin in ultra wideband impulse radio and will have significant application there, but it has potential benefit and application beyond impulse radio to other forms of ultra wideband and beyond ultra wideband to conventional radio systems as well. Nonetheless, it is useful to describe the invention in relation to impulse radio to understand the basics and then expand the description to the extensions of the technology.

Impulse radio has been described in a series of patents, including U.S. Pat. No. 4,641,317 (issued Feb. 3, 1987), U.S. Pat. No. 4,813,057 (issued Mar. 14, 1989), U.S. Pat. No. 4,979,186 (issued Dec. 18, 1990), and U.S. Pat. No. 5,363,108 (issued Nov. 8, 1994) to Larry W. Fullerton. A second generation of impulse radio patents includes U.S. Patent No. 5,677,927 (issued Oct. 14, 1997), U.S. Pat. No. 5,687,169 (issued Nov. 11, 1997), U.S. Pat. No. 5,764,696 (issued Jun. 9, 1998), U.S. Pat. No. 5,832,035 (issued Nov. 3, 1998), and U.S. Pat. No. 5,969,663 (issued Oct. 19, 1999) to Fullerton et al., and U.S. Pat. No. 5,812,081 (issued Sep. 22, 1998), and U.S. Pat. No. 5,952,956 (issued Sep. 14, 1999) to Fullerton, which are incorporated herein by reference.

Uses of impulse radio systems are described in U.S. Pat. No. 6,177,903 (issued Jan. 23, 2001) titled, “System and Method for Intrusion Detection using a Time Domain Radar Array” and U.S. Pat. No. 6,218,979 (issued Apr. 17, 2001) titled “Wide Area Time Domain Radar Array”, which are incorporated herein by reference.

Hybrid Coupler Transmitter and Receiver System

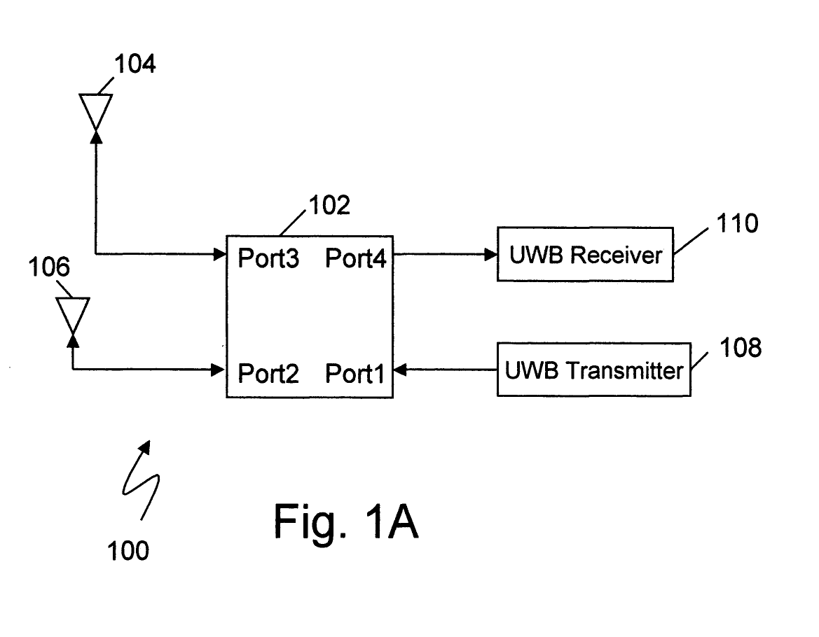

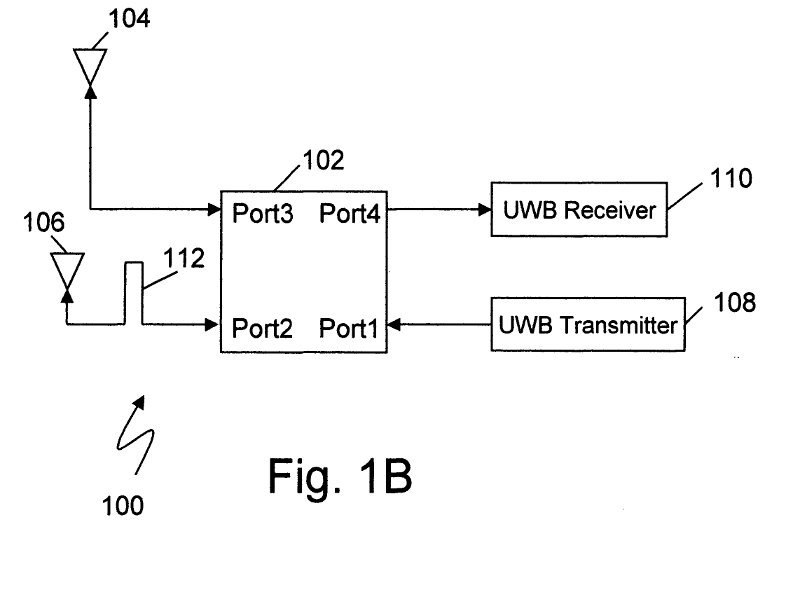

FIG. 1A illustrates a hybrid coupler transmitter and receiver system 100 comprising a UWB transmitter 108 and a UWB receiver 110 coupled to a pair of antennas 104, 106 in accordance with the present invention. Referring to FIG. 1A a hybrid 102 coupler is used to couple a pair of cross polarized antennas 104, 106 to a UWB Transmitter 108 and a UWB receiver 110. The hybrid 102 is a −3 dB 90 degree hybrid 102, also called a quadrature hybrid 102, or a −3 dB directional coupler 102. The hybrid 102 may be constructed using waveguide, coax, or strip line technology. In particular, the hybrid 102 is a network having the properties such that RF power into port 1 is divided equally between ports 2 and 3 and not coupled to port 4. In addition, ports 2 and 3 are 90 degrees shifted from one another. Port 3 may be lead or lag shifted relative to port 2, depending on the particular design of the hybrid 102. Also power into port 4 couples to ports 2 and 3 equally with a 90 degree phase difference between ports 2 and 3. Conversely, signals with the proper (lead or lag) 90 degree phase difference into ports 2 and 3 will add at port 4 and subtract at port 1. With the opposite (lag or lead) 90 degree phase difference, the two signals will subtract at port 4 and add at port 1. Port 1 may also be called the input port, port 2 and port 3 may also be called the zero and 90 degree output ports, respectively (indicating the phase difference from port 2), and port 4 may also be called the isolated port (indicating isolation from port 1 when ports 2 and 3 are terminated in a matching impedance.)

Thus, a signal into port 1 from the transmitter will divide equally, being half power (3 dB attenuation) at ports 2 and 3. The power at port 3 being 90 degrees shifted (lead or lag) from port 2. The signals from ports 2 and 3 are fed to the two cross polarized antennas 104, 106 to yield a circular polarized (CP) transmitted signal, or CP pulse. The right hand circular polarization (RHCP) or left hand circular polarization (LHCP) sense of the transmitted signal is also dependent on whether port 3 is lead or lag shifted in phase from port 2 and also dependent on the polarity of coupling to each antenna 104, 106. The phase is further dependent on the length of transmission line between the hybrid 102 and each antenna 104. Typically, the two lines are equal in length and the antennas 104, 106 are coplanar. If the antennas 104, 106 are not coplanar (one in front of the other), the length of the lines may be adjusted to compensate for the signal delay.

In a duplex communications embodiment, a first transceiver 100 is configured to transmit using RHCP and receive using LHCP pulses while a second transceiver 100 is configured to transmit using LHCP and receive using RHCP pulses. Alternatively, a first transceiver is configured to transmit using LHCP and receive using RHCP pulses while a second transceiver is configured to transmit using RHCP and receive using LHCP pulses.

In a radar embodiment, a CP pulse (either RHCP or LHCP) is transmitted and reflects off of an object. Typically, a first reflection is opposite in CP sense from the incident wave. Thus, an opposite CP sense wave is reflected and received by the antenna 104,106 pair. The opposite CP sense wave thus results in an opposite sense (lead/iag) 90 degree phase difference at ports 2 and 3 of the hybrid 102. Thus, the two signals add at port 4, which is coupled to the receiver and subtract at port 1 which is coupled to the transmitter.

FIG. 1B illustrates an alternative embodiment using a 180 degree hybrid together with a ¼ wave delay 112. The 180 degree hybrid 102 may be a magic T or hybrid ring 102 or other 180 degree hybrid 102. In one embodiment using a 180 degree hybrid 102, port 1 couples 180 degrees out of phase and equally divided in power to ports 2 and 3. Port 4 couples equally to ports 2 and 3 and in phase. A 90 degree shift is introduced by a difference in length of the transmission lines to the two antennas 104, 106, or the antennas 104, 106 are ¼ wave separated, one in front of the other. An added ¼ wave length of transmission line 112 is shown in FIG. 1B. In a narrow band system, the achievement of 90 degree phase shift may be precise for one frequency. In UWB systems, the ¼ wave separation is referred to the center frequency of the UWB signal, and is thus accurate for the center frequency and approximate for frequencies away from the center frequency. However, in real systems this approximation is sufficient to realize the desired operation, the penalty being a slight loss of bandwidth.

Referring to FIG. 1B, the system of FIG. 1B may generate a CP signal of one sense and receive a CP signal of the same sense. For example, the transmitter first transmits a pulse. The pulse is divided by the coupler to two paths of equal power and 180 degree phase shift at ports 2 and 3. Port 2 is then delayed by ¼ wave and coupled to antenna 106. Port 3 is coupled to antenna 104. The two antennas may be arranged to produce RHCP or LHCP, depending on coupling polarities. For this example, assume the two antennas produce RHCP in the direction of a reflecting object that returns a double bounce, RHCP signal. The return signal will thus couple in the same phase relationship i.e. the signal from antenna 106 will be delayed by ¼ wave from the signal from antenna 104. The delayed signal from antenna 106 will then be further delayed another ¼ wave, resulting in ½ wave delay upon reaching port 2. Since the return signals were originally transmitted 180 degrees out of phase and are now further shifted 180 degrees, they are now in phase as a returning signal at ports 2 and 3 and will thus sum at port 4 and be received. Using a similar analysis, an opposite sense reflection is seen to cancel at port 4 and be suppressed.

Alternatively, a zero degree hybrid may be used. Typically input and isolated ports on the 180 degree hybrid may be reversed for zero degree hybrid service, i.e. the transmitter connected to the zero degree port and the receiver connected to the 180 degree port, i.e. ports 2 and 3 are coupled equal in amplitude and in phase to port 1 and coupled equal in amplitude and 180 degrees out of phase to port 4. Such hybrid may be called a zero degree hybrid, referring to the phasing of ports 2 and 3 for a signal from port 1. Again, a ¼ wave delay is introduced in the lines or by way of antenna spacing. In this zero degree hybrid system, it is found that the receiver at port 4 is responsive to same sense CP received signals, and that opposite sense CP signals are suppressed.

Some systems may find it advantageous to receive the second reflection (same sense). For example, second reflection CP systems have been used to suppress rain clutter. Typically an irregular shaped target returns a mix of first and second reflection waves with the first reflection components being predominant; however, rain returns relatively pure first reflection waves. Thus, by suppressing first reflection (opposite sense) CP signals, it is often possible to receive second reflection CP signals (same sense) from a target while suppressing the first reflection (opposite sense) from rain clutter.

In the selection of a hybrid 102, consideration should be given to the bandwidth of the device. Whereas hybrids 102 are available for UWB service, not all hybrids 102 are sufficiently wide band for all applications. Octave and multi-octave high performance Hybrids are now available for most UWB applications.

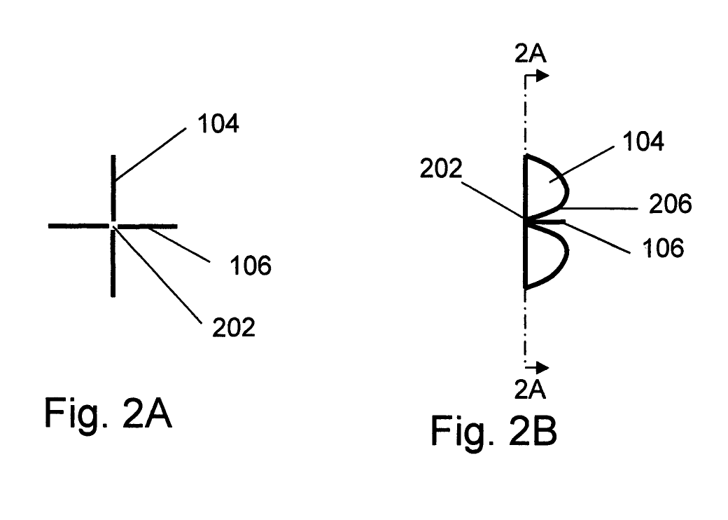

FIG. 2A and FIG. 2B illustrate one exemplary embodiment of the cross polarized antenna 104,106. The antenna arrangement shown in FIG. 2A and FIG. 2B comprises crossed planar slot horn antennas. FIG. 2A is a cross section view at the base of the antenna 104,106.l FIG. 2B is a cross section side view. Referring to FIG. 2A, two tapered slot antennas 104 and 106 are positioned at right angles to one another with their bases coplanar. The two antennas 104 and 106 are each fed at their respective feed points at the center of the antennas 202. Since one antenna receives a signal orthogonally polarized to the other, and of equal power but through the hybrid lagged behind the other by 90 degrees, a circular polarized waveform results. Referring to FIG. 2B, the antenna elements are shown. The antenna profile 206 in the horn gap may follow curves known in the art as exponential, Vivaldi, Heden, and others.

The two antennas are shown coplanar at the base, however, the antennas may be separated, i.e. one positioned in front of the other in the direction of interest (e.g. forward, in the direction of an expected target) or even offset to one side or the other. If the antennas are separated forward, the proper phase relationship may be adjusted or compensated for by introducing a differential delay in the feed networks (transmission lines), i.e. the path from the input port of the hybrid to the target (at a distant point in space) should be different through the two antennas by the 90 degree phase shift for proper circular polarized operation.

Cross polarized planar horn antennas are shown in FIG. 2A and 2B, however, many other types of antennas may be used, such as dipoles, Yagi's, arrays, and such. The antennas may also be used as the feed for a parabolic reflector or other reflector. Dual polarization antenna techniques are also described in US. Pat. No. 5,764,696 (issued Jun. 9, 1998) to Barnes et al., which is incorporated herein by reference.

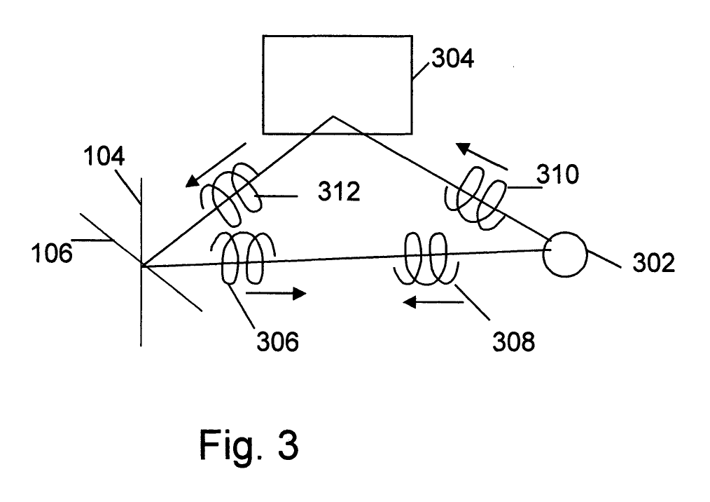

FIG. 3 illustrates the primary and secondary (first multi-path) reflection of a circular polarized signal off of a typical target. Referring to FIG. 3, the cross-polarized antennas 104, 106 transmit a RHCP pulse 306 in the direction of a target 302. The pulse is reflected off of the target in multiple directions and reversed in sense to LHCP as shown at 308 and 310. The reflected pulse returns as a first time reflection 308 to be received by the antennas 104, 106. Because of the signal addition action of the quadrature hybrid, the first reflection signals add at the receiver input and are received. The pulse is also reflected in the direction of a clutter reflector 304 whereupon it receives a second reflection (first multi-path) and reverses in sense again becoming RHCP at 312. The second reflection is then received by the two antennas 104 and 106. Because of the signal subtraction action of the quadrature hybrid, the second reflection cancels at the receiver input and is not received. Because of the signal addition action of hybrid in the transmitter port, the RHCP signal is routed to the transmitter. As long as the output port of the transmitter has a good return loss (low voltage wave standing ratio, VSWR) this signal is properly terminated and absorbed in the transmitter.

Most targets exhibit a strong first reflection. Typically targets with complex shapes exhibit some second reflections, but the first reflection is typically the strongest. Thus the first reflection is the preferred reflection for detection of many targets. The secondary (multi-path) reflections are not received and are therefore suppressed from interfering with the desired first reflection.

CP has a further advantage in suppression of interference. Interfering signals are typically linear polarized. Thus an interfering signal will typically be received by one or the other antenna or a partial response from both antennas with the equivalent of only one antenna and thus does not receive the full benefit of the addition of phase shifted signals from the two antennas, resulting in a 3 dB disadvantage relative to a CP signal. CP has another further advantage in promoting UWB and narrowband interoperability with some important narrow band systems like GPS. Since GPS antennas are RHCP, the transmission at a LHCP signal will significantly reduce coupling to GPS receivers, thereby avoiding interfering with GPS.

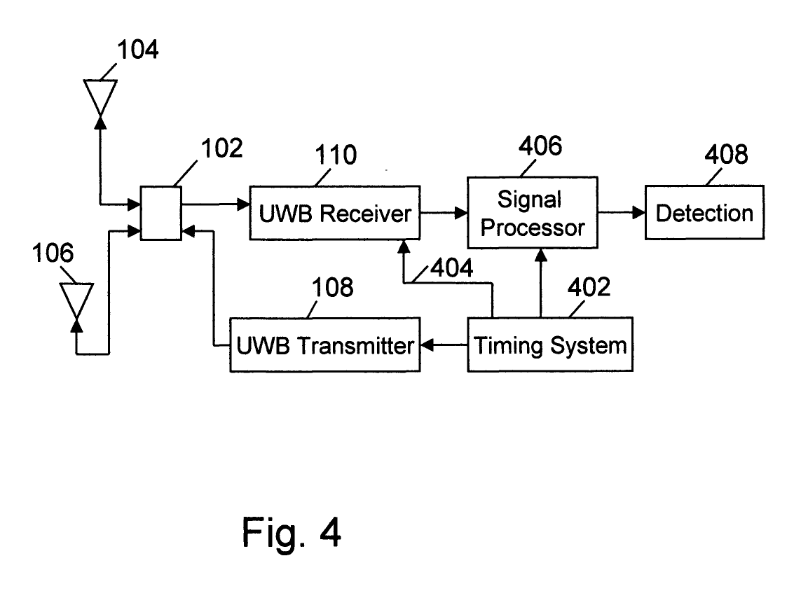

FIG. 4 illustrates a radar system in accordance with the present invention. In FIG. 4, the hybrid 102 is used to couple the receiver and transmitter to the CP antenna 104, 106 array. The radar system further comprises a timing system 402 to coordinate transmitter 108 and receiver 110 timing via timing signals 404. A signal processor 406 further processes receiver 110 output signals to enhance detection, and detection logic 408 further operates on the signal processor 406 output to detect an object.

The radar system may be used as part of a security system, may be used in manufacturing to detect or measure objects on a conveyor or in assembly, may be used to measure properties of materials or objects, may be used as a ground penetrating radar to find objects such as pipes, wires, buried objects, mines, etc, or measure the properties of the ground. The radar may be used for general proximity sensing including a proximity fuze.

For many close range radar and sensing applications, there is difficulty in designing a transmit/receive switch with sufficient speed to allow close range operation. For example, a through wall motion radar for SWAT Team use should be able to detect a perpetrator directly on the other side of a wall (about 6 inches). The T/R switch must permit a relatively high power pulse to be coupled to the antenna, switch off the pulse and couple the receiver to the antenna for observation of microvolt signals and must switch consistently in a few nanoseconds. For close range operation, (for example, within 3 meters) the T/R switch becomes a challenging design problem and may significantly raise the cost and complexity of the device.

The hybrid may also be used with a T/R switch. A T/R switch coupling port 4 to the receiver will receive a reduced transmit pulse amplitude compared with a directly connected T/R switch. Thus, the design and power handling requirements of the switch may be eased by inclusion of the hybrid, the receiver coupling power being reduced by the hybrid isolation. In some applications, the design requirements may be eased to the point that a T/R switch is unnecessary. Thus, duplex operation may be achieved without using a T/R switch.

For close range applications, the system of FIG. 4 provides an alternative to a T/R switch. The hybrid may provide 20 dB to 30 dB of isolation between the receiver 110 and transmitter 108 as long as very low return loss antennas are used. This permits the receiver to operate coupled to the antenna during a transmit pulse so that the receiver can receive signals almost immediately after the transmit pulse without a T/R switch. The hybrid reduces the transmit pulse coupling to the receiver below damage levels and potentially below overload levels, permitting continuous receive operation, potentially overlapping the transmit pulse time. The isolation afforded by the hybrid also reduces potential noise from transmitter output stages that may reduce the signal to noise ratio of a received signal. In some situations, there may be residual ring down from a transmit pulse that is present during the receiver sampling time. Such ring down energy may often be subtracted from the receiver output, if it is consistent and predictable.

In a further embodiment of the invention, polarization may be used to improve the unambiguous range of a radar by periodically changing the polarization within a pulse train. The pulse train may comprise a single pulse or a sequence of pulses, such as a Barker coded sequence of pulses. For example, if the pulse repetition rate is 10 Mpps, or 100 ns per pulse, the unambiguous range is 15 meters. If, alternatively, a pulse is sent RHCP and then 100 ns later a pulse is sent LHCP and then 100 ns later repeating the RHCP and so on, then the repeating interval is 200 ns. Since the receiver receiving a reflection from the RHCP pulse will see a significant attenuation in the reflection from the LHCP pulse, and conversely the receiver receiving a reflection from the LHCP pulse will see a significant attenuation in the reflection from the RHCP pulse, the resulting unambiguous range is 30 meters. A cross over switch coupling a −3 dB hybrid to a transmitter and a receiver may be used to alternate polarization states. The cross over switch would alternately switch the transmitter between the input port and the isolated port and simultaneously alternately switch the receiver between the isolated port and the input port.

IV. Conclusion

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof. Thus, the breadth and scope of the present invention should not be limited by any of the above-described exemplary embodiments, but should be defined only in accordance with the following claims and their equivalents.

All cited patent documents and publications in the above description are incorporated herein by reference.

We claim

1. A transmitter and receiver system comprising:
a first antenna and a second antenna arranged in a cross polarized configuration;
a hybrid coupler having
an input port coupled to said transmitter;
a first output port coupled to said first antenna through a first transmission network;
a second output port coupled to said second antenna through a second transmission network;
an isolated port coupled to said receiver.

2. The system of claim 1, wherein the hybrid is a quadrature hybrid.

3. The system of claim 1, further including a quarter wave differential delay between said first transmission network and said second transmission network, and wherein the hybrid is a 180 degree hybrid.

4. The system of claim 1, further including a quarter wave differential delay between said first transmission network and said second transmission network, and wherein the hybrid is a zero degree hybrid.

5. The system of claim 1, wherein the transmitter is an impulse transmitter.

6. The system of claim 1, wherein the receiver is an impulse receiver.

7. The system of claim 1, wherein the receiver is a narrow band receiver.

8. The system of claim 1, wherein the receiver signal path includes a Transmit/Receive switch.

9. The system of claim 1, wherein the receiver receives while the transmitter is transmitting.

10. The system of claim 1, wherein the hybrid coupler comprises waveguide technology.

11. The system of claim 1, wherein the hybrid coupler comprises coaxial technology.

12. The system of claim 1, wherein the hybrid coupler comprises strip line technology.

13. The system of claim 1, further including a timing system for providing timing signals to the transmitter and to the receiver and further including a signal processor for further processing receiver signals, wherein the receiver is configured to receive reflections from said transmitter signals from objects within a short distance.

14. The system of claim 13, wherein the short distance is three meters.

15. A method for transmitting and receiving circular polarized signals, comprising:
providing a first antenna and a second antenna arranged in a cross polarized orientation;
providing a hybrid coupling device, said hybrid coupling device having:
an input port coupled to a transmitter;
a first output port coupled to said first antenna through a first coupling network;
a second output port coupled to said second antenna through a second coupling network;
an isolated port coupled to a receiver;
a first signal path comprising the path from said input port through said hybrid, then through said first antenna to a distant point;
a second signal path comprising the path from said input port through said hybrid, then through said second antenna to said distant point;
adjusting the phase difference between the first signal path and second signal path to be substantially ninety degrees.

16. The method of claim 15, wherein the adjusting of phase is accomplished by varying the difference between the path length of the first coupling network and the path length of the second coupling network.

17. The method of claim 15 wherein the adjusting is accomplished by varying the distance between the first antenna and the second antenna.

18. A method for transmitting and receiving circular polarized signals comprising:
providing a first antenna and a second antenna arranged in a cross polarized orientation;
providing a hybrid coupling device, said hybrid coupling device having:
an input port coupled to a transmitter;
a first output port coupled to said first antenna through a first coupling network;
a second output port coupled to said second antenna through a second coupling network;
an isolated port coupled to a receiver;
transmitting a circular polarized pulse;
receiving a circular polarized reflection from said pulse;
suppressing a circular polarized reflection of opposite handed sense from the received circular polarized reflection.

19. The system of claim 18, wherein the received circular polarized reflection is opposite handed sense to the transmitted circular polarized pulse.

20. The system of claim 18, wherein the received circular polarized reflection is the same handed sense to the transmitted circular polarized pulse.
